(19) United States
(12) Patent Application Publication
(10) Pub. No.: US 2025/0242765 A1
(43) Pub. Date: Jul. 31, 2025

(54) ARCH GARNISH

(71) Applicant: SUBARU CORPORATION, Tokyo (JP)

(72) Inventors: Tatsuya KAWASHIMA, Tokyo (JP); Morio OKADA, Tokyo (JP); Shigeru INATOMI, Tokyo (JP)

(73) Assignee: SUBARU CORPORATION, Tokyo (JP)

(21) Appl. No.: 19/025,364

(22) Filed: Jan. 16, 2025

(30) Foreign Application Priority Data
Jan. 31, 2024 (JP) 2024-012545

(51) Int. Cl. B60R 13/04

(52) U.S. Cl. CPC B60R 13/04

(57) ABSTRACT

An arch garnish is disposed spanning a bumper and a fender panel and attached to the fender panel by a clip. The clip includes a fixing part and an engaging part. The arch garnish includes: a clip attachment part to which the clip is fixed; and an inclined part protruding toward the fender panel. The fender panel includes a clip engaging part corresponding to the clip attachment part of the arch garnish. The fixing part of the clip is fixed to the clip attachment part of the arch garnish. The engaging part of the clip is engaged with the clip engaging part of the fender panel. The inclined part includes an abutting part facing a portion of the fender panel near the clip engaging part. The abutting part is inclined such that a distance to the clip increases toward a tip side of the inclined part.

### CROSS-REFERENCE TO RELATED APPLICATIONS

The present application claims priority from Japanese Patent Application No. 2024-012545 filed on Jan. 31, 2024, the entire contents of which are hereby incorporated by reference.

### BACKGROUND OF THE INVENTION

### Field of the Invention

The present invention relates to an arch garnish.

### Description of Background Art

Japanese Unexamined Patent Application Publication (JP-A) No. 2021-70354 describes attaching a garnish to a vehicle body panel with clips. The entire contents of this publication are incorporated herein by reference.

### SUMMARY OF THE INVENTION

According to one aspect of the present invention, an arch garnish for being positioned spanning a bumper and a fender panel includes a clip attachment part that fixes a clip, and an inclined part protruding toward a fender panel. The fender panel includes a clip engaging part corresponding to the clip attachment part, the clip includes a fixing part that is fixed to the clip attachment part and an engaging part that engages with the clip engaging part of the fender panel, the inclined part includes an abutting part facing a portion of the fender panel near the clip engaging part, and the abutting part is inclined such that a distance to the clip increases toward a tip side of the inclined part.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a side view of a vehicle provided with an arch garnish according to an embodiment of the present invention;

FIG. 2 is a side view of the arch garnish and an attachment structure thereof according to the embodiment of the present invention;

FIG. 3 is a sectional view of the attachment structure of the arch garnish according to the embodiment of the present invention;

FIG. 4A is a sectional view of the arch garnish according to the embodiment of the present invention, in a state in which a clip is extracted in a collision; and

FIG. 4B is a sectional view of the arch garnish according to the embodiment of the present invention, in a state in which the clip is extracted in a collision.

### DETAILED DESCRIPTION OF THE EMBODIMENTS

Embodiments will now be described with reference to the accompanying drawings, wherein like reference numerals designate corresponding or identical elements throughout the various drawings.

An arch garnish 18 and a vehicle 10 according to an embodiment of the present invention will be described in detail below with reference to the drawings. In the following description, the vehicle inner side and the vehicle outer side may be simply referred to as the inner side and the outer side.

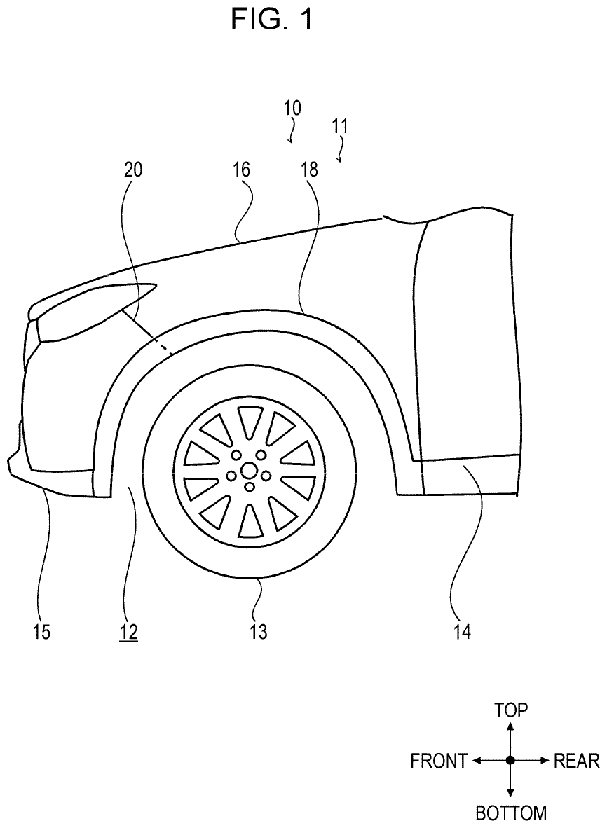

FIG. 1 is a side view of the vehicle 10 provided with the arch garnish 18.

The vehicle 10 is, for example, a passenger car. A wheel well 12 is provided in the side surface of the vehicle front part of the vehicle 10, and a tire 13 is disposed inside the wheel well 12.

A bumper 15 is provided at the front end of a vehicle body 11. The bumper 15 is a long member made of a synthetic resin plate and extends in the vehicle width direction on the front surface of the vehicle body 11.

The fender panel 16 is a part of a vehicle body panel made of a metal plate, and is disposed behind the bumper 15 on the side surface of the vehicle body 11. The front part of the wheel well 12 is surrounded by the bumper 15, and the rear part of the wheel well 12 is surrounded by the fender panel 16. A boundary 20 is a boundary between the bumper 15 and the fender panel 16. A door 14 is disposed behind the fender panel 16. In FIG. 1, a portion of the boundary 20 covered by the arch garnish 18 is indicated by a dashed line.

The arch garnish 18 is disposed spanning the bumper 15 and the fender panel 16 so as to surround the wheel well 12. The arch garnish 18 is a substantially arch-shaped plate-like long member.

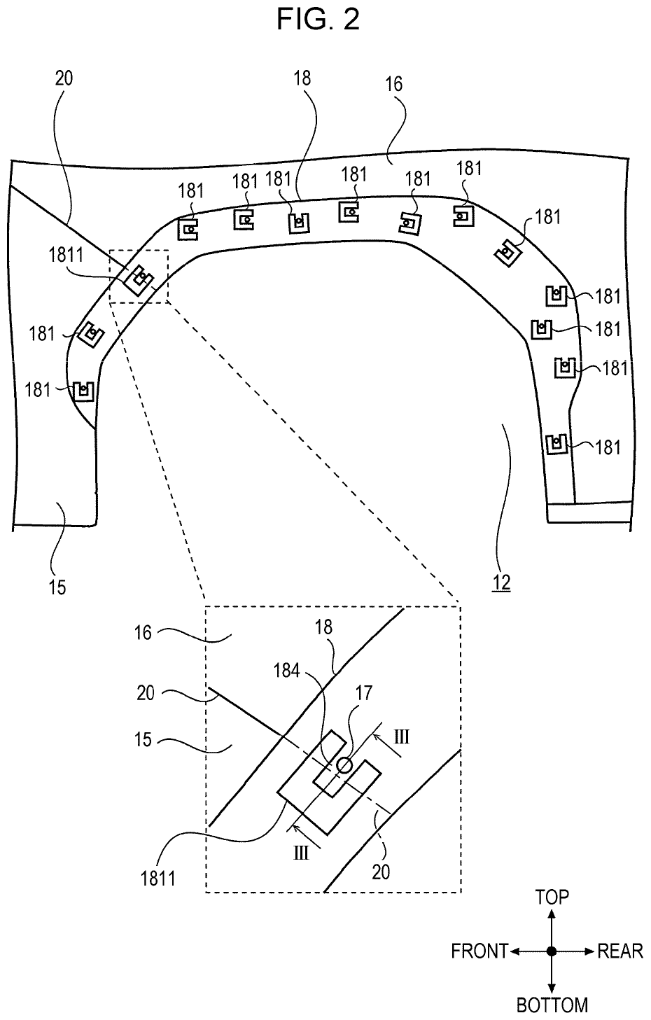

FIG. 2 is a side view of the arch garnish 18 and an attachment structure thereof. In FIG. 2, a portion of the arch garnish 18 corresponding to the boundary 20 is enclosed by a dashed-line rectangle and illustrated in an enlarged manner.

The arch garnish 18 is a plate-shaped member made of a synthetic resin and is disposed so as to surround the wheel well 12. The front part of the arch garnish 18 is attached to the bumper 15, and the rear part of the arch garnish 18 is attached to the fender panel 16.

Multiple clip attachment parts 181 are provided on a surface facing the bumper 15 and the fender panel 16, that is, an inner surface, of the arch garnish 18. The clip attachment parts 181 are portions to be fixed to the fender panel 16 or the bumper 15 by with clips 17 described below. The clip attachment parts 181 are provided along the longitudinal direction of the arch garnish 18. The front part of the arch garnish 18 is fixed to the bumper 15 with the clip attachment parts 181. The rear part of the arch garnish 18 is attached to the fender panel 16 with the clip attachment parts 181.

A clip attachment part 1811 is provided at a portion corresponding to the boundary 20. The clip attachment part 1811 is disposed so as to straddle the boundary 20. As described below, the clip 17 fixed to the clip attachment part 1811 is extracted from the fender panel 16 when a collision occurs. This structure reduces the impact energy transmitted to the fender panel 16 and suppresses deformation and damage of the fender panel 16 when a minor collision occurs at the front part of the vehicle 10. Furthermore, a clip fixing part 184 is formed by partially cutting out the clip attachment part 1811. The clip fixing part 184 is a portion into which the clip 17 described below is inserted.

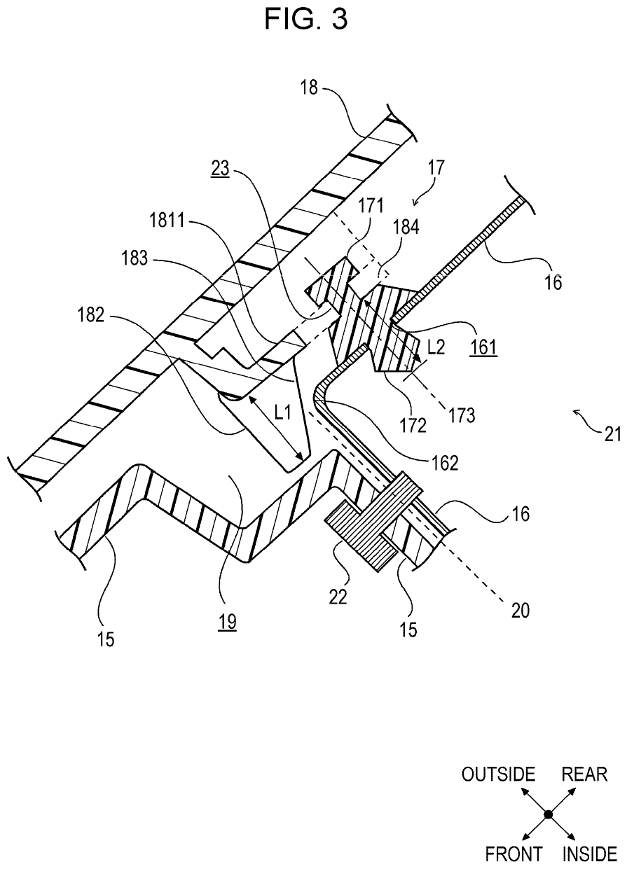

FIG. 3 is a sectional view of the attachment structure of the arch garnish 18. FIG. 3 is a sectional view taken along line III-III in FIG. 2.

The arch garnish 18 has the clip attachment part 1811 to which the clip 17 is fixed, and an inclined part 182 protruding toward the fender panel 16. The arch garnish 18, the clip attachment part 1811, and the inclined part 182 are molded as a single component of a synthetic resin.

The clip attachment part 1811 is a portion to which the clip 17 is fixed. The clip attachment part 1811 has a substantially hook-shaped cross section extending from the inner surface of the arch garnish 18 toward the inside of the arch garnish 18.

The inclined part 182 is a substantially plate-shaped portion extending inward from the front end side of the clip attachment part 1811. The inclined part 182 has an abutting part 183.

The abutting part 183 is disposed so as to face a portion of the fender panel 16 near a clip engaging part 161, that is, a contact part 162. The abutting part 183 is inclined such that the distance to a center line 173 of the clip 17 increases toward the tip of the inclined part 182, or the inside. The abutting part 183 is inclined forward, toward the inner side.

The clip fixing part 184 is a portion formed by partially removing the clip attachment part 1811. As will be described below, the clip 17 is inserted and fixed to the clip fixing part 184.

The fender panel 16 is provided with the clip engaging part 161 and the contact part 162.

The clip engaging part 161 is a portion formed by partially removing the fender panel 16, and is formed so as to correspond to the clip attachment part 1811 of the arch garnish 18. As will be described below, the clip 17 is removably engaged with the clip engaging part 161.

The contact part 162 is a corner formed by bending the fender panel 16 inward at a substantially right angle at the boundary 20. As will be described below, when a collision occurs, the abutting part 183 of the inclined part 182 comes into contact with the contact part 162.

A housing region 19 is a recessed region formed by bending the rear end of the bumper 15 inward. The housing region 19 is provided in the vicinity of the boundary 20 and the contact part 162. The housing region 19 is a region for housing the inclined part 182.

The clip 17 includes a fixing part 171 and an engaging part 172. The clip 17 is an engaging member made as a single component of a synthetic resin. The thin portion of the fixing part 171 of the clip 17 is inserted and fixed to the clip fixing part 184 of the clip attachment part 1811. As will be described below, when a minor collision occurs, the fixing part 171 of the clip 17 is not disengaged from the clip attachment part 1811. The engaging part 172 of the clip 17 is engaged with the clip engaging part 161 in the fender panel 16. As will be described below, when a minor collision occurs, the engaging part 172 of the clip 17 is disengaged from the clip engaging part 161.

The fixing part 171 of the clip 17 is separated from the front end of the clip fixing part 184. In other words, a gap 23 is provided between the front end of the clip fixing part 184 and the fixing part 171. The gap 23 is a portion for allowing relative movement between the clip 17 and the arch garnish 18 to protect the fender panel 16 when a minor collision occurs. The length of the gap 23 in the front-rear direction may be greater than or equal to the distance between the contact part 162 and the abutting part 183. This remarkably increases the effect of protecting the fender panel 16.

The length by which the inclined part 182 protrudes inward is larger than the length by which the clip 17 protrudes inward. For example, the length by which the inclined part 182 protrudes from the inner surface of the clip attachment part 1811 toward the fender panel 16 is defined as L1. The length by which the clip 17 protrudes from the inner surface of the clip attachment part 181 toward the fender panel 16 is defined as L2. In this case, L1 is set to be larger than L2. This increases the amount by which the inclined part 182 moves outward by coming into contact with the contact part 162 when a minor collision occurs, as described below. Thus, it is possible to reliably extract the engaging part 172 of the clip 17 from the clip engaging part 161.

The rear-side end of the bumper 15 is bent so as to extend inward. Similarly, the front end of the fender panel 16 is bent so as to extend inward. The rear-side end of the bumper 15 and the front-side end of the fender panel 16 are fastened by a fastener 22.

The clip attachment part 1811, the clip 17, the inclined part 182, the abutting part 183, the housing region 19, and the like can also be referred to as a panel attachment structure 21. The presence of the panel attachment structure 21 allows the clip 17 to be detached from the fender panel 16 when a minor collision occurs, and thus to suppress damage, deformation, and the like of the fender panel 16.

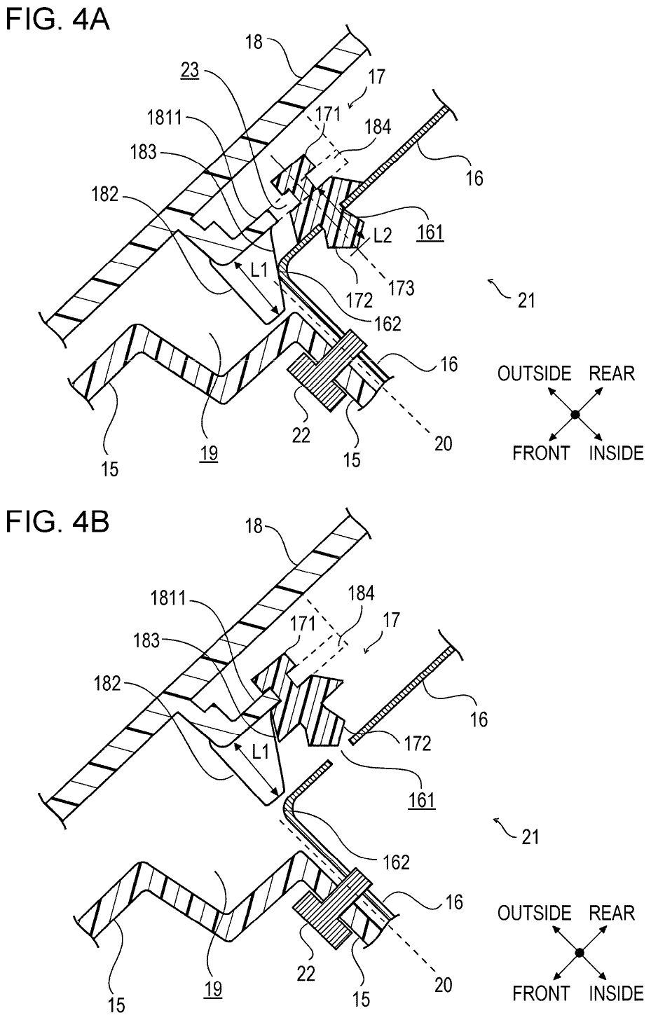

FIGS. 4A and 4B are sectional views illustrating, in time series, a state in which the clip 17 is extracted from the arch garnish 18 when a collision occurs.

Referring to FIG. 4A, when a minor collision occurs in the front part of the vehicle 10, an impact that displaces the bumper 15 and the arch garnish 18 rearward is generated. As a result, the arch garnish 18 is displaced rearward. When the arch garnish 18 is displaced rearward, the abutting part 183 of the inclined part 182 comes into contact with the contact part 162. As a result, the inclined part 182 is guided by the contact part 162 and moves rearward and outward. At this time, the clip attachment part 1811 and the clip 17 also move rearward and outward.

A gap 23 is present between the fixing part 171 of the clip 17 and the front end of the clip fixing part 184. Hence, even if the arch garnish 18 moves rearward due to a minor collision, the impact is prevented from being transmitted to the fender panel 16 via the clip 17. Hence, damage or deformation of the fender panel 16 due to the minor collision is suppressed.

Referring to FIG. 4B, when the arch garnish 18 moves further rearward and outward, the fixing part 171 of the clip 17 moves to the front end of the clip fixing part 184. This eliminates the gap 23 illustrated in, for example, FIG. 4A. Furthermore, the engaging part 172 of the clip 17 is extracted from the clip engaging part 161 of the fender panel 16. The inclined part 182 is disposed further outward than the fender panel 16. As illustrated in FIG. 3, the length L1 by which the inclined part 182 protrudes inward is larger than the length L2 by which the clip 17 protrudes (FIG. 4A). Hence, the inclined part 182 that comes into contact with the contact part 162 sufficiently displaces the clip 17 outward, so that the clip 17 can be reliably extracted from the clip engaging part 161.

In this embodiment, the clip 17 is extracted from the fender panel 16 at the boundary 20 between the bumper 15 and the fender panel 16. Hence, it is possible to prevent the impact energy input to the bumper 15 from being input to the fender panel 16 via the arch garnish 18. Accordingly, deformation and damage of the fender panel 16 in the event of a minor collision can be suppressed.

Technical ideas that can be grasped from the above-described embodiment will be described together with advantages thereof.

An arch garnish according to an embodiment of the present invention is disposed spanning a bumper and a fender panel and attached to the fender panel by a clip. The clip includes a fixing part and an engaging part. The arch garnish includes: a clip attachment part to which the clip is fixed; and an inclined part protruding toward the fender panel. The fender panel includes a clip engaging part corresponding to the clip attachment part of the arch garnish. The fixing part of the clip is fixed to the clip attachment part of the arch garnish. The engaging part of the clip is engaged with the clip engaging part of the fender panel. The inclined part includes an abutting part facing a portion of the fender panel near the clip engaging part. The abutting part is inclined such that a distance to the clip increases toward a tip side of the inclined part. According to an arch garnish of an embodiment of the present invention, when a minor collision occurs at the front part of the vehicle, the abutting part of the inclined part comes into contact with the fender panel, allowing the clip to be extracted from the fender panel. Because the arch garnish is at least partially detached from the fender panel, it is possible to suppress deformation of the fender panel due to the minor collision.

In an arch garnish according to an embodiment of the present invention, the length by which the inclined part protrudes from the clip attachment part toward the fender panel is larger than the length by which the clip protrudes from the clip attachment part toward the fender panel. According to an arch garnish of an embodiment of the present invention, when a collision occurs, the abutting part of the inclined part is guided by the fender panel over a sufficient length. Thus, the engaging part of the clip can be reliably extracted from the fender panel.

In an arch garnish according to an embodiment of the present invention, a contact part facing the abutting part of the inclined part is provided on the fender panel of the clip engaging part. According to an arch garnish of an embodiment of the present invention, when a collision occurs, the contact part of the fender panel can satisfactorily guide the abutting part of the inclined part.

In an arch garnish according to an embodiment of the present invention, a housing region for storing the inclined part is provided in the vicinity of the contact part. According to an arch garnish of an embodiment of the present invention, a region for housing the inclined part protruding toward the fender panel is secured.

In an arch garnish according to an embodiment of the present invention, the fixing part of the clip is inserted into the clip fixing part provided in the clip attachment part, and a gap is provided between the front end of the clip fixing part and the fixing part. According to an arch garnish of an embodiment of the present invention, when a minor collision occurs, the presence of the gap between the front end of the clip fixing part and the fixing part prevents an impact from being transmitted to the fender panel 16 via the clip. Thus, deformation and damage of the fender panel 16 is prevented.

Although embodiments of the present invention has been described above, the present invention is not limited to embodiments, and can be modified without departing from the scope of the present invention.

For example, referring to FIG. 2, in this embodiment, when a minor collision occurs, the clip 17 corresponding to the clip attachment part 1811 alone is extracted, and the other clips 17 are not extracted from the corresponding clip attachment parts 181. However, this configuration may be changed. For example, a configuration, that is, the panel attachment structure 21 described above, in which some the clips 17 are extracted from the corresponding clip attachment parts 181 may be employed. For example, it is possible to employ a configure in which, in the event of a minor collision, some clips 17 are extracted from the corresponding clip attachment parts 181 in the front part of the arch garnish 18, and the clips 17 are not extracted in the rear part of the arch garnish 18. This configuration can significantly suppress deformation of the fender panel 16 in the event of a minor collision.

According to an arch garnish of an embodiment of the present invention, when a minor collision occurs at the front part of the vehicle, the abutting part of the inclined part comes into contact with the fender panel, allowing the clip to be extracted from the fender panel. Because the arch garnish is at least partially detached from the fender panel, it is possible to suppress deformation of the fender panel due to the minor collision. Furthermore, the repairability of the vehicle after a minor collision is increased.

In recent years, vehicles in which a garnish is attached to an outer surface of a panel of the vehicle for the purpose of improving the appearance design and the like have been increasing. The garnish, which is a long member, is attached to a vehicle panel via clips positioned at equal intervals along the longitudinal direction. The clips are engaged with the vehicle panel on one side thereof and fixed to the garnish on the other side thereof. Japanese Unexamined Patent Application Publication (JP-A) No. 2021-70354 describes attaching a garnish to a vehicle body panel with clips. In JP-A No. 2021-70354, there is room for improvement from the standpoint of protecting the vehicle panel in a collision.

In a structure in which the garnish is disposed spanning the bumper and the panel, when a vehicle collision occurs, the collision energy generated by the collision propagates through the garnish. Hence, even if the vehicle collision is a minor collision, the collision energy generated by the minor collision is transmitted from the bumper to the panel via the garnish, sometimes damaging the panel. Hence, when a minor collision occurs, not only the bumper but also the panel is repaired or replaced.

It is desirable to provide a garnish capable of protecting a panel in the event of an accident.

An aspect of the present invention provides an arch garnish disposed spanning a bumper and a fender panel and attached to the fender panel by a clip. The clip includes a fixing part and an engaging part. The arch garnish includes: a clip attachment part to which the clip is fixed; and an inclined part protruding toward the fender panel. The fender panel includes a clip engaging part corresponding to the clip attachment part of the arch garnish. The fixing part of the clip is fixed to the clip attachment part of the arch garnish. The engaging part of the clip is engaged with the clip engaging part of the fender panel. The inclined part includes an abutting part facing a portion of the fender panel near the clip engaging part. The abutting part is inclined such that a distance to the clip increases toward a tip side of the inclined part.

Obviously, numerous modifications and variations of the present invention are possible in light of the above teachings. It is therefore to be understood that within the scope of the appended claims, the invention may be practiced otherwise than as specifically described herein.

1. An arch garnish for being positioned spanning a bumper and a fender panel, comprising:
a clip attachment part that fixes a clip; and
an inclined part protruding toward a fender panel,
wherein the fender panel includes a clip engaging part corresponding to the clip attachment part, the clip includes a fixing part that is fixed to the clip attachment part and an engaging part that engages with the clip engaging part of the fender panel, the inclined part includes an abutting part facing a portion of the fender panel near the clip engaging part, and the abutting part is inclined such that a distance to the clip increases toward a tip side of the inclined part.

2. The arch garnish according to claim 1, wherein a length by which the inclined part protrudes from the clip attachment part toward the fender panel is larger than a length by which the clip protrudes from the clip attachment part toward the fender panel.

3. The arch garnish according to claim 1, wherein a contact part facing the abutting part of the inclined part is provided on the fender panel of the clip engaging part.

4. The arch garnish according to claim 3, wherein a housing region configured to house the inclined part is provided near the contact part.

5. The arch garnish according to claim 4, wherein the housing region is provided at a boundary between the fender panel and the bumper.

6. The arch garnish according to claim 1, wherein the fixing part of the clip is inserted into a clip fixing part provided in the clip attachment part, and a gap is provided between a front end of the clip fixing part and the fixing part.

7. The arch garnish according to claim 2, wherein a contact part facing the abutting part of the inclined part is provided on the fender panel of the clip engaging part.

8. The arch garnish according to claim 7, wherein a housing region configured to house the inclined part is provided near the contact part.

9. The arch garnish according to claim 8, wherein the housing region is provided at a boundary between the fender panel and the bumper.

10. The arch garnish according to claim 2, wherein the fixing part of the clip is inserted into a clip fixing part provided in the clip attachment part, and a gap is provided between a front end of the clip fixing part and the fixing part.

11. The arch garnish according to claim 3, wherein the fixing part of the clip is inserted into a clip fixing part provided in the clip attachment part, and a gap is provided between a front end of the clip fixing part and the fixing part.

12. The arch garnish according to claim 4, wherein the fixing part of the clip is inserted into a clip fixing part provided in the clip attachment part, and a gap is provided between a front end of the clip fixing part and the fixing part.

13. The arch garnish according to claim 5, wherein the fixing part of the clip is inserted into a clip fixing part provided in the clip attachment part, and a gap is provided between a front end of the clip fixing part and the fixing part.
